(19) United States
(12) Patent Application Publication
(10) Pub. No.: US 2017/0061360 A1
(43) Pub. Date: Mar. 2, 2017

(54) INTERACTIVE CHARTS WITH DYNAMIC PROGRESS MONITORING, NOTIFICATION, AND RESOURCE ALLOCATION

(71) Applicant: SMARTSHEET.COM, INC., Bellevue, WA (US)

(72) Inventors: Erik Rucker, Bellevue, WA (US); Thomas P. Maliska, Jr., Bellevue, WA (US)

(73) Assignee: SMARTSHEET.COM, INC., Bellevue, WA (US)

(21) Appl. No.: 14/842,738

(22) Filed: Sep. 1, 2015

(51) Int. Cl. G06Q 10/06

(52) U.S. Cl. CPC G06Q 10/063114

(57) ABSTRACT

A visual environment implements technical solutions to permit rapid, contextual display of status information for scheduled items. The visual environment includes interactive charts (e.g., interactive Gantt charts) with dynamic progress monitoring (e.g., in the form of dynamic progress views with specialized, multi-function burn-down graphs, trend lines, or the like). Automated notifications and modifications can be generated based on inputs to or outputs from the visual environment and/or a related back-end computer system. Contextual presentation of possible or actual changes to the scheduled items can be provided by the visual environment (e.g., in the form of updates to a dynamic progress view). Real-time data inputs by users can be tracked by the back-end computer system, which can make updates to the visual environment, such as updating a trend line in a dynamic progress view.

### BACKGROUND

Prior software tools have attempted to provide users with the ability to plan and track progress of projects. For example, prior spreadsheet tools have allowed users to enter information about the progress of a project, such as by entering an expected completion date for a task, entering a list of workers that will be responsible for completing a task, or adding a notation when a particular task has been completed. Such tools can be shared by multiple users of computers on a network, with users being able to access and edit shared documents to reflect and track progress and plan future tasks.

Yet, prior software tools have also created technological problems of their own. For example, if 50 users involved in a project have access to a spreadsheet being used to track progress of the project, they may all wish at different times to update the spreadsheet to reflect their own progress or to access the spreadsheet to gain knowledge about the project from the updates of other users. This creates several technical problems, such as how to provide updates to users without locking the document to editing, and how to avoid consumption of valuable computing resources as users constantly access the spreadsheet to check for updates. It is also a technical and computational challenge to resolve updates of different users to avoid inconsistency and logical contradictions within the information that is presented. If inconsistencies and contradictions become apparent, or if a project simply does not seem to be progressing as expected, even more computing resources may be consumed as users continually check for progress or send communications to each other about a stalled project or a contradictory project plan. The problem is further limited to technical and computational solutions when the number of information items in the history, and ongoing and planned work queues, is in the thousands or millions, requiring significant computational and data resources to collect, interact with, and report on those items.

Many tools are applied for planning and tracking progress of projects and related information items. Human activity does not automatically make a record of itself, or of progress, other than in human memory and experience. For example, a new home contractor may know how far along construction is, and what delays have occurred or remain likely; the unschooled homeowner may not. For another person to discern progress, technical tools can be applied. Historically, these tools have proven very important to the technical organization of time and direction of the worker(s). Methods associated with the technical management of work and related items include time recorders/clocks; daily planners; calendars, planning meetings and agendas; to-do lists, email; and project planner software. These methods are typically deployed by supervisors to track and manage workers' activity. In recent technology, for example, in a Gantt chart, project tasks are typically shown with reference to a timeline. A task may be represented with a graphic, such as a bar, in the chart. The characteristics of the graphic and its position in the chart can provide information about the task. For example, the length of a bar that represents a particular task can provide an indication of how long the task is expected to take to complete. The position of the bar along the timeline can indicate when the task is scheduled to begin or to be completed. This type of display provides an overview, albeit static, of the state of a task or item.

Graphical tools can be used to take advantage of the information provided in Gantt charts. According to U.S. Pre-Grant Publication No. 2010/0217418, by Fontanot et al., “computer-based graphical tools based on the metaphor of the interactive Gantt-chart are used. . . . Usually, such tools give to the user the ability to move on a screen, by means of a pointing device (mouse, trackball or touch-screen), the graphical objects that represent the tasks that are part of the production schedule.” According to U.S. Pre-Grant Publication No. 2010/0017740, by Gonzalez Veron, et al., “project management application may display a project schedule timeline in conjunction with the Gantt chart or other schedule data. The timeline provides a summary of the project schedule by visually representing the schedule along a timescale from the start of the project until the finish. The timeline may also display crucial time information about the project including phases and milestones.”

According to U.S. Pre-Grant Publication No. 2014/033117, by Holler et al., “Progress and status reports may be displayed graphically. For example, a ‘dashboard’ user interface may display multiple graphical reports. Possible graphical reports include burn-down charts, velocity charts, burn-up charts, Gantt charts, parking lot reports, scope change, defect trending, test case status, and defect actuals. A burn-down chart illustrates remaining work vs. time.”

However, these solutions do not provide a technical solution to tracking items and interactive projects at scale, with all their dependencies and users. Despite providing features such as project schedule timelines, previous interactive Gantt charts do not offer the ability to easily determine the actual progress of tasks or the underlying interactions, dynamics between items, and measurable progress directly from the display, which is especially important for agile project management techniques. Therefore, users of such charts are required to personally investigate the progress of tasks in the timeline, often in side communications with personnel engaged in the task, which costs valuable time and resources and inherently limits the utility of such tools and limits the trust value of the information in the display. Although burn-down graphs, burn-up graphs, trend graphs, and the like are known to be used to track progress of things in limited ways, they have previously been viewed as separate tools that provide a different, and quite limited, view of a project.

While a visual display of progress is one of the benefits of prior project management techniques, they do not have the advantages in computational and dynamic interaction of the technical solutions described below.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computing device displays at least a portion of an interactive chart (e.g., a task row) presented in a first view. The computing device receives a first user request (e.g., by touch or gesture input received via a touchscreen of the computing device) for a change in the view, and updates the view responsive to the request. The updated view comprises a dynamic progress view. The dynamic progress view may include a burn-down graph. A task row may be height-adjusted to accommodate a dynamic progress view (e.g., by adjusting the height to display a burn-down graph in addition to other information in the task row).

The computing device may receive a second user request for a change in the view and further update the view responsive to the second user request. In such a scenario, the corresponding portion of the interactive chart may be an expandable task row, and the further updated view may include representations of a plurality of individual tasks associated with the expandable task row. The expandable task row may include an expand/collapse element, and the second user request may be associated with the expand/collapse element.

In another aspect, a computing device presents a dynamic progress view (which may include a burn-down graph) for at least a portion of an interactive chart, receives user input associated with the dynamic progress view, and automatically performs one or more of the following steps responsive to the received user input: (a) presenting additional information about a task or project associated with the interactive chart; (b) generating a notification associated with the interactive chart; (c) updating resource allocation for a task associated with the interactive chart; or (d) adjusting a projected completion time for a task associated with the interactive chart. For example, steps (b) and (d) may be performed, and the notification of step (b) may include information relating to the adjusted projected completion time of step (d). As another example, steps (b) and (c) may be performed, and the notification of step (b) may include information relating to the updated resource allocation of step (c).

In examples described herein, the computing device may be in communication with a remote computer system (e.g., one or more server computers), and the dynamic progress view may include project information (e.g., project schedule information, resource allocation information, etc.) received from the remote computer system. The dynamic progress view also may include project information received from a local project cache on the computing device. Changes to the project information (e.g., changes made by a user interacting with the computing device) may be synchronized back to the remote computer system.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an illustration of a touch-enabled mobile computing device configured to present a user interface for an interactive chart to a user, according to the present disclosure;

FIG. 2 is a screen shot of an illustrative interactive Gantt chart, according to the present disclosure;

FIGS. 3A and 3B are screen shots depicting an illustrative transition from a first view to a dynamic progress view for a task row of an interactive chart, according to the present disclosure;

FIGS. 4A-E depict aspects of illustrative dynamic progress views, according to the present disclosure;

FIG. 5 is a screen shot depicting illustrative dynamic progress views in which a burn-down graph is provided for a task group, with additional burn-down graphs provided for individual tasks within the group, according to the present disclosure;

FIG. 6A is a screen shot depicting an illustrative dynamic progress view including a burn-down graph for a group of independent tasks within a broader task group, according to the present disclosure;

FIG. 6B is a screen shot depicting independent tasks of the group in FIG. 6A in newly revealed task rows with respective dynamic progress views, according to the present disclosure;

FIGS. 7 and 8 are diagrams depicting an illustrative embodiment of a dynamic progress view with interactive elements according to the present disclosure;

FIG. 9 is a system diagram depicting an illustrative embodiment of a computer system for interactive charts according to the present disclosure;

FIGS. 10 and 11 are flow charts illustrating computer-implemented methods according to embodiments of the present disclosure; and

FIG. 12 is a block diagram that illustrates aspects of an illustrative computing device appropriate for use in accordance with embodiments of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

### Overview of Illustrative Interactive Charts

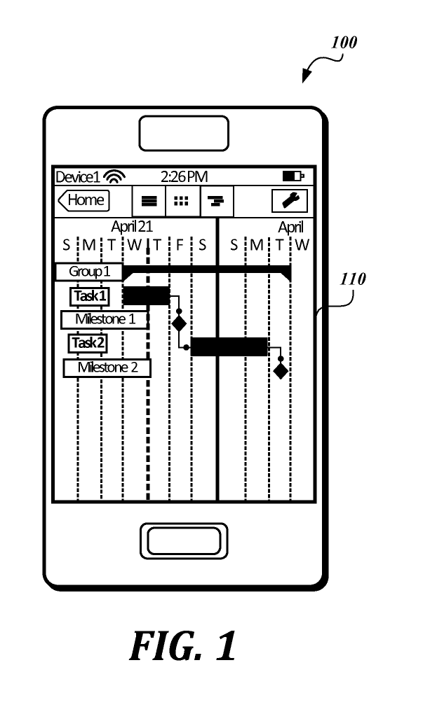

FIG. 1 depicts an illustrative computing device 100 (e.g., a touch-enabled mobile computing device) configured to present a user interface for an interactive chart 110 to a user. In the example shown in FIG. 1, the interactive chart is an interactive Gantt chart. As described in further detail below, a dynamic progress view can be displayed for a particular task or group of tasks in a Gantt chart.

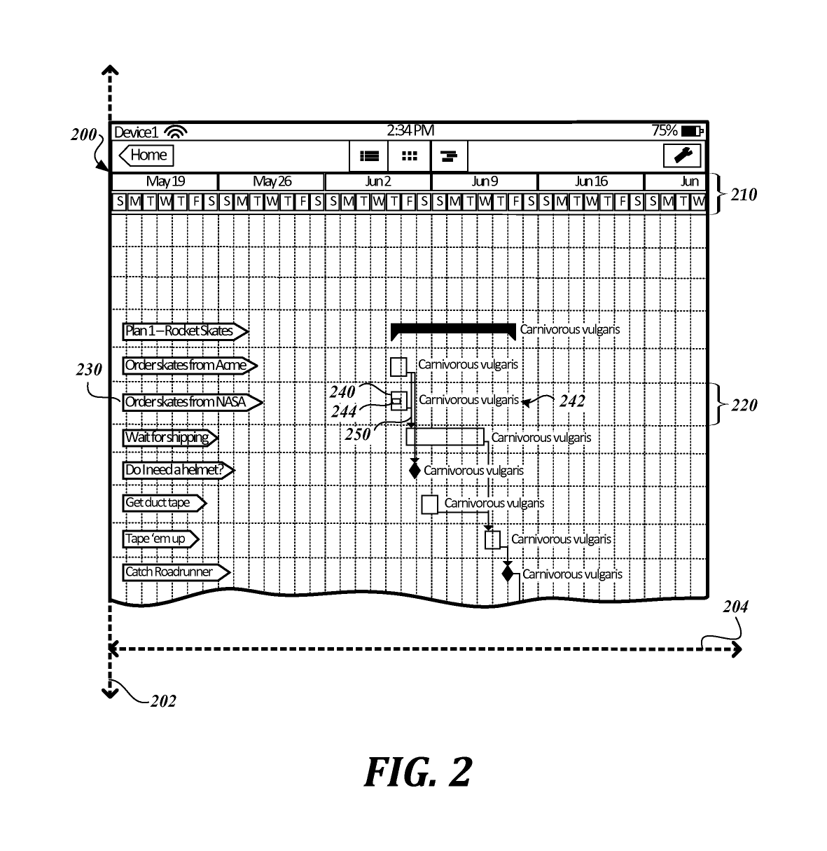

FIG. 2 is a screen shot of an illustrative interactive Gantt chart 200 having a time axis 204 and a task axis 202. In the example shown in FIG. 2, a header row 210 associated with the time axis 204 is displayed across the top of the interactive Gantt chart 200. The time axis 204 is associated with a time scale that includes two levels of hierarchy (e.g., days and weeks) in the header row 210. Alternatively, other types of time scales also can be used.

In the example shown in FIG. 2, task rows are associated with tasks. As used herein, a “task row” includes a graphical representation of data associated with one or more tasks. The visual content of task rows may include task name labels, task bars, task bar labels, connection lines, and/or other elements. An illustrative task row 220 includes a task name label 230 associated with a task bar 240 and connection lines 250. The connection lines 250 can be used to show dependency relationships (e.g., with arrows showing direction of precedence from a predecessor task to a successor task).

The task bar 240 has an associated task bar label 242 that provides additional information about the task, such as the person or entity responsible for completing the task. The information to be displayed in the task bar label 242 may be selectable (e.g., automatically or by a user) or predefined. Alternatively, the task bar label 242 can be omitted or presented in some other way.

In the example shown in FIG. 2, the task bar 240 contains a progress bar 244 that shows progress associated with the corresponding task. The progress bar 244 does not, however, provide detailed information about whether the task will be completed on schedule, or any details about how progress has evolved over time.

### Dynamic Progress Monitoring, Notifications, and Resource Allocation

Embodiments described herein provide a visual environment that implements technical solutions to permit rapid, contextual display of status information for one or more scheduled items. The visual environment includes interactive charts (e.g., interactive Gantt charts) with dynamic progress monitoring (e.g., in the form of dynamic progress views with specialized, multi-function burn-down graphs, trend lines, or the like). Automated notifications and modifications can be generated based on inputs to the visual environment (e.g., via interactive elements of a dynamic progress view) or outputs from the visual environment and/or a related back-end computer system. Contextual presentation of possible or actual changes to the scheduled items can be provided by the visual environment (e.g., in the form of updates to a dynamic progress view). The back-end computer system can perform automated processing to modify scheduled items based on, e.g., status information and underlying constraints. Real-time data inputs by users can be tracked by the back-end computer system, which can make updates to the visual environment, such as updating a trend line in a dynamic progress view. This type of dynamic computing system permits a level of interaction with ongoing work by a large group of users.

According to some embodiments of the present disclosure, solutions are provided for the management and presentation of information in interactive charts with selectable and customizable dynamic progress views, which allow the actual progress of a task or other scheduled item to be quickly and accurately understood. As used herein, a dynamic progress view depicts progress (e.g., an amount of work remaining) against time. The dynamic progress view includes a visual representation (e.g., in the form of a trend-line or spark-line) of a rate of progress. The dynamic progress view may depict a present rate, a historic rate, and/or a projected future rate of task completion. The dynamic progress view also may depict the present, historic, or projected future rate versus a planned rate of completion (e.g., with separate lines to represent each). Different time periods in a dynamic progress view may be represented distinctively (e.g., with different colors, shadings, etc.). For example, time periods may be represented in different colors depending on whether the respective time period is past or future time. A customized color scheme may be used to indicate different times or conditions, e.g., green for a time elapsed (past time) region, blue for an on-schedule trend line, yellow for a behind-schedule trend line, or red for stalled trend line. The presentation of the time allotted for completion can be made to contrast with the trend-line for projected completion, to enhance the visual effect of the dynamic progress view.

As mentioned above, task rows and the elements within them can be presented in different views. Views can change in response to, e.g., user requests. User requests may include requests to (1) refresh a current view; (2) select from among available views (including, e.g., a calendar view, a Gantt view, and a dynamic progress view), or switch between views; and (3) expand/collapse views (if applicable). In at least one embodiment, refreshing a view involves updating task data for a task row based on a selected cell or cells in an underlying spreadsheet. Selected cell data can be, for example, content in the cell, metadata about the cell, and data derived from or about the cell from the sheet itself.

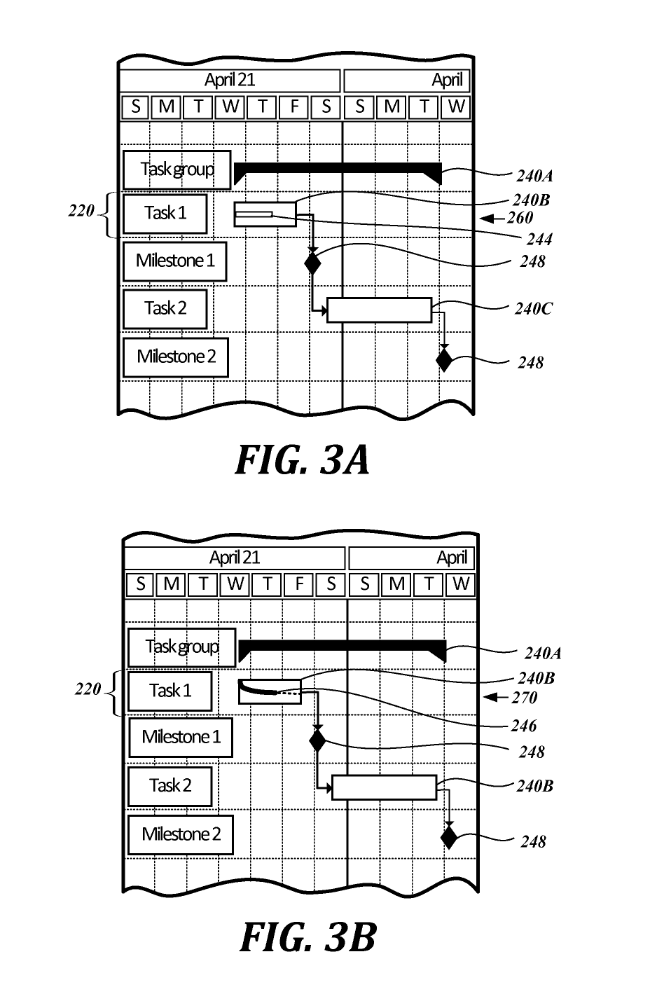

FIGS. 3A and 3B are screen shots of a portion of an interactive chart that illustrate a transition from a first view 260 (FIG. 3A) to a dynamic progress view 270 (FIG. 3B) for a task row 220. In the example shown in FIG. 3A, a group task bar 240A has small triangles at either end indicating the extent of a corresponding group of tasks (Task 1 and Task 2) and milestones (Milestone 1 and Milestone 2). Task bars 240B represent tasks. In the first view 260, the task bar that represents Task 1 (from which Task 2 depends) includes a progress bar 244. Alternatively, a different first view (e.g., without a progress bar) may be used. Milestone markers 248 represent milestones. Milestone markers (e.g., a diamond shape) can be considered a special type of task bar associated with a milestone. Task name labels, task bars, and the like may be customizable in terms of border, color, etc. For example, task bars can be customized to represent different types of tasks, types of milestones, task status, milestone status, etc.

FIG. 3B depicts a dynamic progress view 270 for a task row 220 in the interactive chart depicted in FIG. 3A, in which the progress bar 244 has been replaced with a burn-down graph 246 that plots work remaining over time. The dynamic progress view 270 provides a more accurate description of the progress of Task 1 compared with the progress bar 244. For example, the dynamic progress view 270 shows that actual progress on Task 1 (represented by the thicker line in the burn-down graph 246) has leveled out. With this additional information, a user can quickly determine, e.g., with reference to a current trend line (represented by the thinner, dotted line in the burn-down graph 246), that Task 1 is not likely to be completed on schedule, given the current rate of progress. The user also can easily determine that Milestone 1 is at risk of not being reached, and that the start of dependent tasks (such as Task 2) and the overall completion of the task group may be delayed as a result.

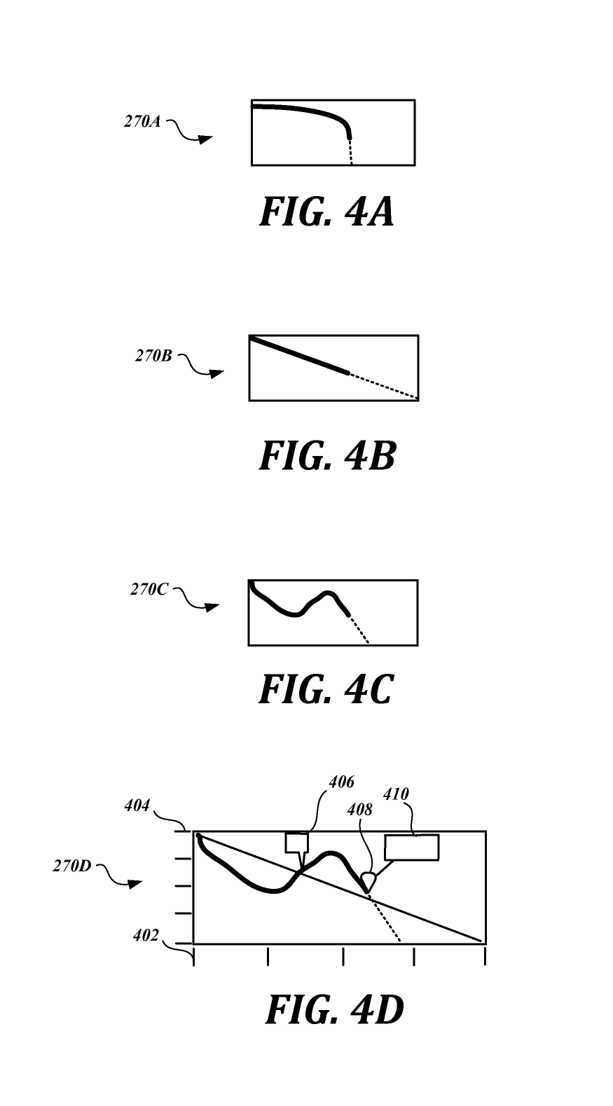

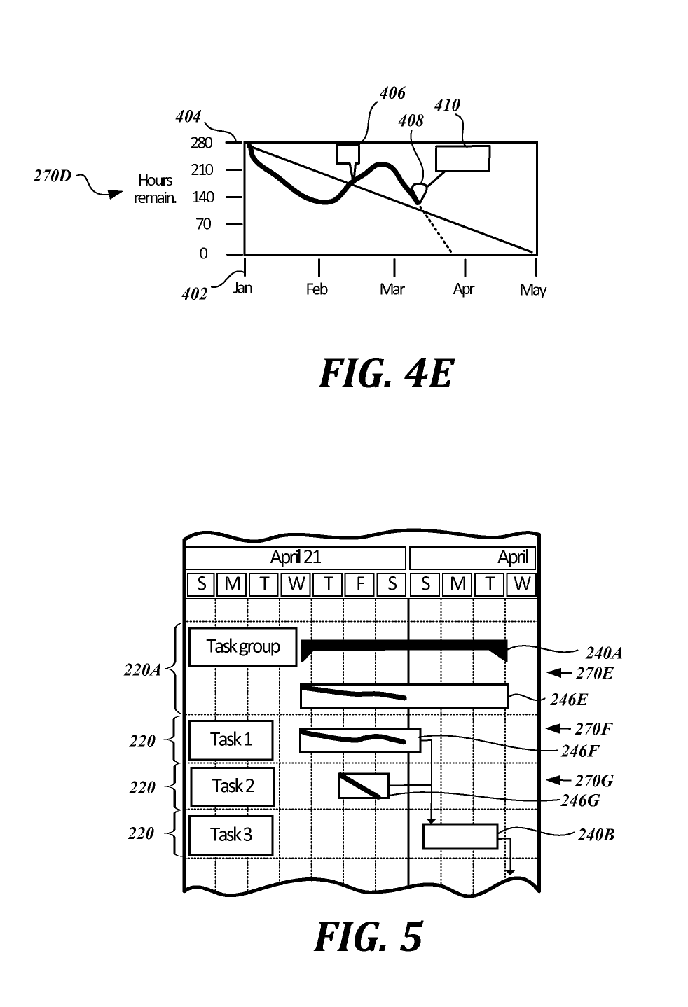

FIGS. 4A-E depict aspects of other possible dynamic progress views. The dynamic progress view 270A depicted in FIG. 4A shows that actual progress has accelerated rapidly after a period of little progress, with the current trend line indicating that the task is likely to be completed ahead of schedule. The dynamic progress view 270B depicted in FIG. 4B shows that actual progress has been steady, with the current trend line indicating that the task is likely to be completed on time. The dynamic progress view 270C depicted in FIG. 4C shows that actual progress was initially good, and then regressed (e.g., as new work was discovered). Progress then accelerated rapidly with the current trend line indicating that the task is likely to be completed ahead of schedule.

The dynamic progress view 270D depicted in FIG. 4D provides an alternative to the chart shown in FIG. 4C, with additional features such as tick marks 402 along the X-axis (e.g., representing 0%, 25%, 50%, 75%, and 100% time elapsed), tick marks 404 along the Y-axis (e.g., representing work hours remaining), and a thin diagonal line provided as a reference that illustrates expected progress over time as a comparison to the actual progress represented by the thicker line. FIG. 4E represents a zoomed-in view of the dynamic progress view 270D shown in FIG. 4D. The zoomed-in view may be presented, for example, on request by a user, which may be provided via various forms of user input. The zoomed-in view adds further detail on the axes, allowing the user to more clearly see progress.

The examples shown in FIGS. 4D and 4E also illustrate an ability to attach comments (represented by comment icon 406), the content of which may be shown, for example, when a mouse hover or other user input event occurs in the vicinity of the comment icon 406. The examples shown in FIGS. 4D and 4E also include an inflection marker 408, which can be used to indicate a transition in the trend line between measuring historical data and projected data. A status report 410 or other information (e.g., current resource assignments, such as worker assignments) may be shown, for example, when a mouse hover or other user input event occurs in the vicinity of the inflection marker 408. The inflection marker 408 can be color coded to indicate additional information, such as a relationship between trend information and project goals. For example, a blue marker may be used to indicate expected early completion, a green marker may be used to indicate expected on-time completion, a yellow marker may be used to indicate that an extension of time or allocation of additional resources may be required, and a red marker may be used to indicate that project activity has flatlined, making determination of an expected completion date more difficult.

It will be understood with the flexibility that is offered by described dynamic progress views, other progress scenarios also can be depicted in such views.

FIG. 5 depicts dynamic progress views 270E, 270F, 270G for task rows in an interactive chart in which a burn-down graph 246E is provided for a task group, with additional burn-down graphs 246F and 246G being provided for individual tasks within the group, allowing progress to be tracked on a group basis as well as a task-by-task basis. In the example shown in FIG. 5, progress has been made on Task 1, and Task 2 has been completed, as shown in the respective dynamic progress views for those tasks. Waterfall dependencies exist within this group, as indicated by the arrows. Task 3 depends from both Task 1 and Task 2, and therefore awaits completion of Task 1. The dynamic progress view 270E for the group provides information on progress for the overall task group and includes, in this example, the burn-down graph 246E below the group task bar 240A in an expandable task row 220A. In at least one embodiment, expansion of a task row (e.g., increasing height of the task row) may occur in response to a switch from a first view to a dynamic progress view. The task row may return to an unexpanded state if the view is switched back to the first view.

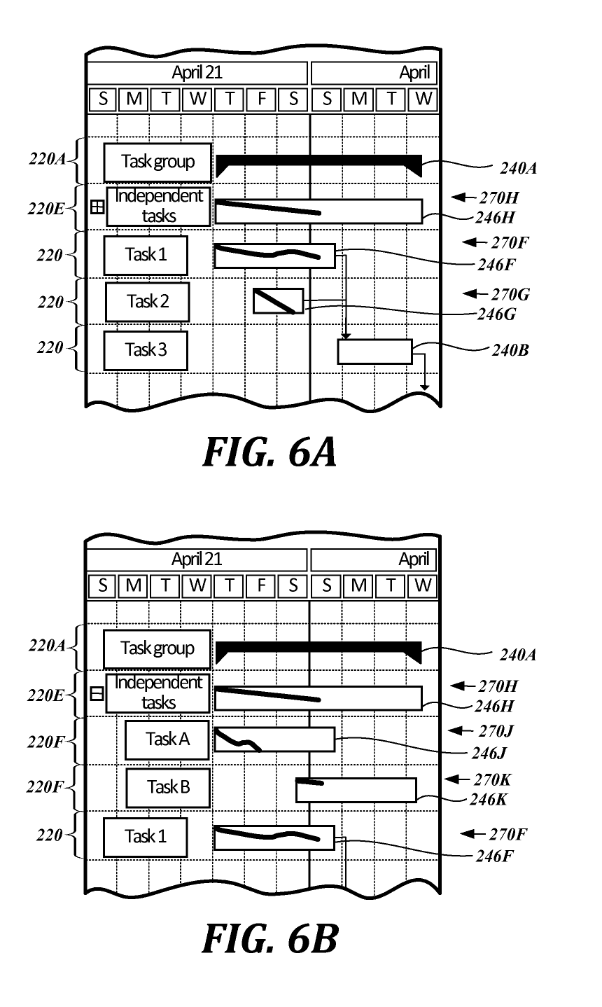

FIG. 6A depicts a dynamic progress view including a burn-down graph 246H for a group of independent tasks within a broader task group. In the example shown in FIG. 6A, the independent tasks in the expandable task row 220E are shown in a collapsed state. In the example shown in FIG. 6B, the independent tasks (Task A, Task B), which were previously hidden when collapsed, are shown in newly revealed task rows 220F with respective dynamic progress views 270J, 270K. (The task rows for Task 1, Task 2, and Task 3, shown in FIG. 6A, have been moved down in FIG. 6B.) Thus, progress can be indicated for the subgroup of independent tasks, as well as for the individual, independent tasks within the subgroup. Although Task A and Task B are shown in new task rows 220F that are distinct from task row 220E, it should be understood that the expandable task row 220E could also be configured to show newly revealed tasks in a vertically expanded version of a single task row 220E.

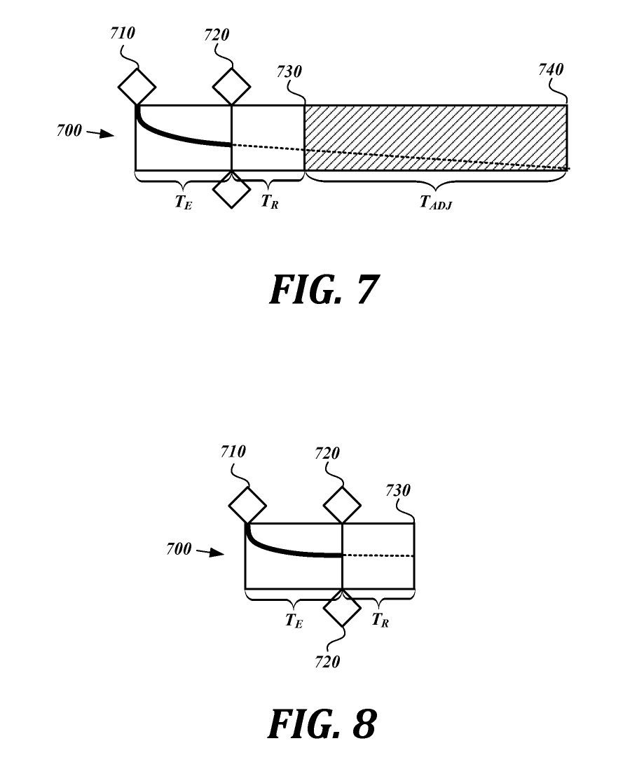

FIGS. 7 and 8 depict an illustrative embodiment of a dynamic progress view 700 with interactive elements. In the examples shown in FIGS. 7 and 8, the interactive elements include a start point element 710 (e.g., a diamond-shaped marker) to indicate a start point for a task, a current time element 720 (e.g., a vertical line with diamond-shaped markers) to indicate a current time for the task, and an end-of-time-allocation (ETA) element 730 (e.g., a vertical line at the end of a task bar).

The interactive elements 710 and 720 can be clicked, tapped, dragged, or otherwise activated to interact with the interactive chart via the dynamic progress view. By interacting with the interactive chart via the dynamic progress view (e.g., with the elements shown or in other ways), a user can obtain information about a task, cause a notification to be generated, cause updates to resource allocation for a task, adjust a projected completion time for a task, or invoke a combination of such functionality or other functionality. Examples of such interactions and related functionality are described in detail below.

In the examples shown in FIGS. 7 and 8, T_{E} indicates time elapsed for the respective task. As time passes, information that relates to the task can be accumulated and updated. Such information may be stored and/or presented in the form of various record-keeping and report formats, including without limitation a notification log, a user action log, change/update history, a resource log, a percent completed, a rate of completion or a related slope for trend line, or the like. Information collected during time T_{E} may be accessed, for example, by interacting with element 710 or by tapping, clicking, or otherwise interacting with the region of the chart associated with time T_{E}.

In the examples shown in FIGS. 7 and 8, the current time element 720 is positioned at a border between elapsed time (T_{E}) and time remaining (T_{R}) for the task. T_{R} signifies the time remaining between the current time and a planned time of completion. As in the examples shown in FIGS. 4A-4D, the dashed trend line (which may be determined using a curve-fitting algorithm) indicates a projected rate of completion. The trend line can be extended to predict the time by which the task is expected to finish. The end point of the trend line is another possible interactive element, and may provide, for example, actual progress information (e.g., if the end point is in the past) or projected progress information (e.g., if the end point is in the future).

FIG. 7 represents a delayed completion case, in which the task represented by task bar 700 is expected to be completed, but not on time. In the example shown in FIG. 7, a time required element 740 is a vertical line positioned at the end point of the trend line. The position of the end point to the right of the ETA element 730 indicates that the task is not expected to finish on time. This projection may lead to analysis of task dependencies and decisions on whether to reallocate resources to the task, extend allotted time for the task, or other potential changes. Such changes, if made, can then be resolved with other, related tasks in a project, as needed. In FIG. 7, an extension of time for the task has been proposed automatically and is represented in the shaded region labeled T_{ADJ}, (adjusted time). This shaded region can be represented with shading, highlighting, or some other visual feature that is presented to a user to clearly show the user that the time for the task has been extended.

FIG. 8 represents a stalled case, in which progress on the task represented by task bar 700 has effectively come to a standstill. In the example shown in FIG. 8, the time required element 740 may not be present because the end point of the trend line, given the current flat slope, may be undefined. As in the delayed completion case illustrated in FIG. 7, this projection may lead to analysis (e.g., automatic analysis) of task dependencies and decisions on whether to reallocate resources to the task, or other potential changes. Such changes, if made, can then be resolved with other, related tasks in a project, as needed. However, in the example shown in FIG. 8, the allotted time is not extended, in view of the fact that extending the allocated time may not help if some other factor is preventing any progress on the task.

The examples shown in FIGS. 7 and 8 also represent cases in which automated messages may be sent to users, managers, or other entities based on current conditions, interactions with elements in the dynamic progress view, or other factors. Such messages may include progress information (including, for example, whether a task has been classified as stalled or delayed), proposed adjustments (such as reallocation of workers, time, or other resources), constraints (such as limitations on resources, an unextendable completion date, etc.), or the like.

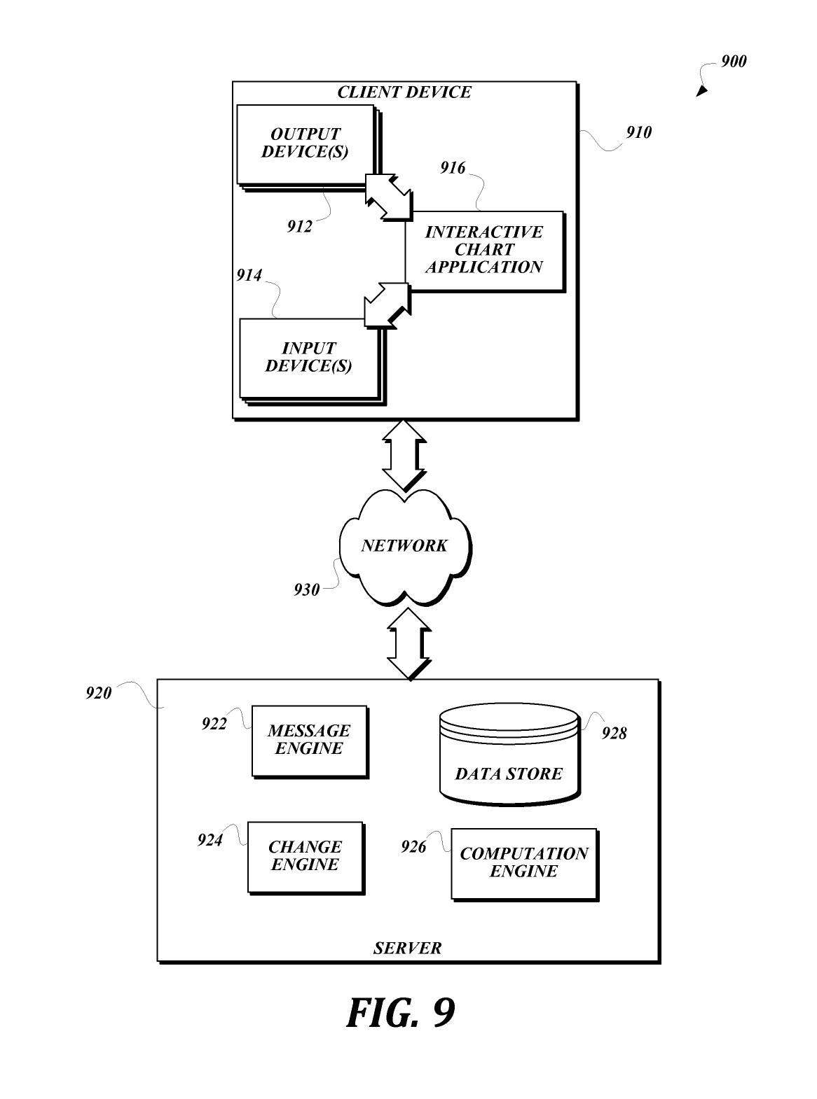

FIG. 9 is a system diagram showing aspects of a computer system according to the present disclosure. As shown in FIG. 9, a client device 910 communicates with a remote computer system (e.g., server 920) via a network 930. In at least one embodiment, the client device is a mobile computing device such as a smart phone, tablet computer, or the like. (Some aspects of the client device 910 and server 920, such as communication modules, memory, processors, operating systems, and the like, are not shown in FIG. 9 for ease of illustration.) The client device includes one or more output devices 912 (e.g., a display, a speaker, etc.), one or more input devices 914 (e.g., buttons, a microphone, etc.), and an interactive chart application 916 that presents an interactive chart to a user. In some embodiments, one or more of the input devices 914 and one or more of the output devices 912 may be combined in a single device, such as a touchscreen. The input devices 914 and the output devices 912 allow the user to interact with the interactive chart application 916. The client device can then communicate data corresponding to such interactions to the server 920 via the network 930. Although only one client device 910 is shown in the system 900 for ease of illustration, the system 900 may be adapted to accommodate any number of client devices.

The server 920 can process input obtained from the client device 910 and/or other devices. For example, the server 920 can accept input indicating completion of a task, an update on the amount of work remaining for a task, or the like. The server 920 can store such data in a data store 928 and/or use such data for further processing. For example, the server 920 can use a change engine 924 to push corresponding changes to the interactive chart. The changes may be based on underlying calculations (e.g., updates to expected time remaining before a task is completed) performed by a computation engine 926. The server 920 may use a message engine 922 to generate messages relating to the interactive chart. For example, the server 920 may use the message engine 922 to automatically generate messages to be transmitted (e.g., to client device 910 via the network 930) to users that may be affected by an update to a task.

Messages may be automatically generated by the message engine 922 based on data that indicates current status, constraints, or the like. Similarly, automated changes, if permitted, may be made by the change engine 924 based on such data. The timing of automatically generated messages or changes also may be based on such data. For example, if a projected rate of completion indicates that a task is stalled or will be delayed, and the time remaining is less than a specified threshold, a warning message may be sent to a manager or other responsible entity. The specified threshold may depend on the condition of the task. For example, a stalled task may need to be addressed earlier than a delayed task, so the threshold time remaining for sending a warning message on a stalled task may be greater than for a delayed task.

Messages also may be sent to provide regular status reports at predefined times (e.g., when 25% or 50% of the allocated time for a task has elapsed), when particular conditions are met (e.g., when a task is 25% or 50% completed), or the like. For example, at 25% time remaining, a message engine may generate a message including a condition statement (for example, tasks completed and remaining, items yet to be received, reviewers assigned but not active) and, if appropriate, a dependency statement (for example, other items and persons relying upon completion).

The design of described embodiments allows tracking of user changes to task parameters (e.g., allocated time, or resources such as workers, equipment, etc., for a task); tracking of actual work (e.g., completed tasks or sub-tasks); tracking and adjustment of resource, schedule and user assignments; and implementation of management mandates relating to schedule, resource and user time allocations. The design of described embodiments also allows for partitioning of underlying metadata and generation of reports, which can be automatically updated and produced on request. Such reports may include reports specific to past time in a task or project, such as who worked on a task, tasks completed, changes in task assignments, etc., or future time in a task or project, such as who is assigned to a future task or subtask, tasks remaining, task assignments yet to be made, etc. In addition to separate reports, some information may be available by directly inspecting the dynamic progress view of the interactive chart. For example, a task bar or trend-line can be segmented in different colors or shading to indicate who was assigned to a task during a particular period of time, to indicate a future task that has not been assigned to a worker yet, etc.

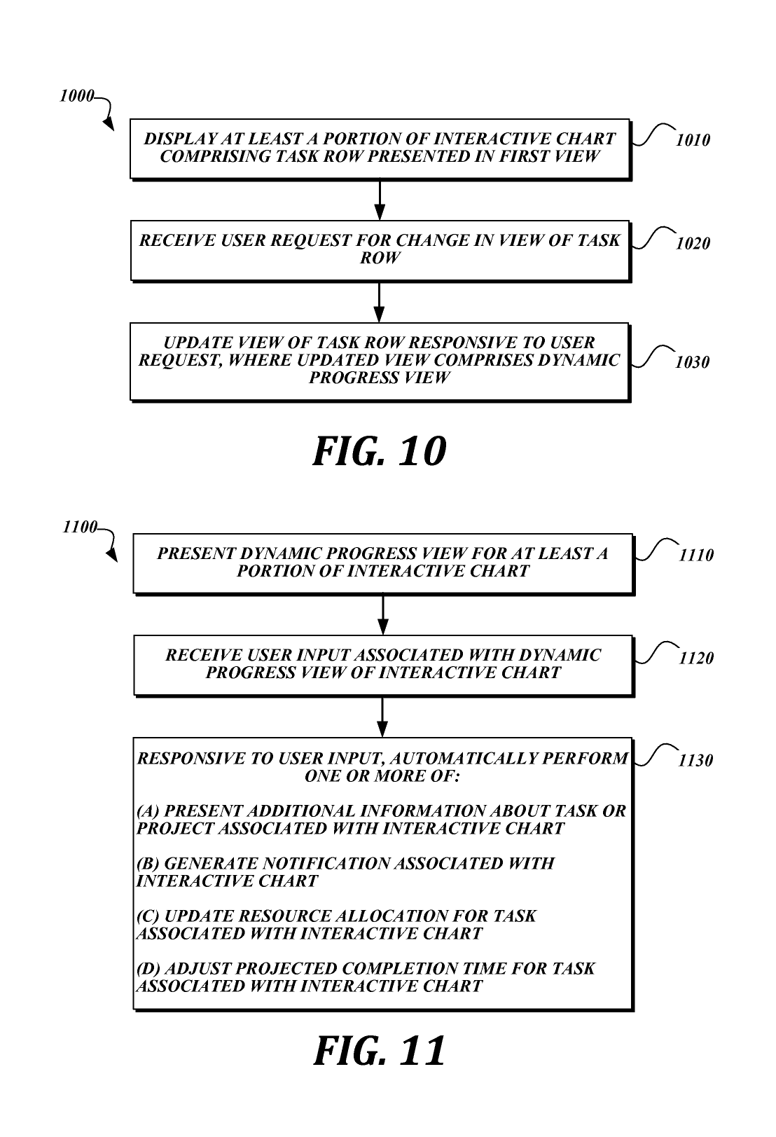

FIGS. 10 and 11 are flow charts illustrating computer-implemented methods according to embodiments of the present disclosure. In the illustrative method 1000 shown in FIG. 10, at step 1010, a computing device (e.g., the computing device 100 shown in FIG. 1) displays at least a portion of an interactive chart (e.g., a task row) in a first view. At step 1020, the computing device receives a first user request for a change in the view. At step 1030, the computing device updates the view responsive to the user request, and the updated view includes a dynamic progress view. In the dynamic progress view, a task row may include a burn-down graph. The task row may be height-adjusted to accommodate the dynamic progress view (e.g., by adjusting the height to display a burn-down graph in addition to other information in the task row).

The computing device may receive a second user request for a change in the view and further update the view responsive to the second user request. In such a scenario, the further updated view may include representations of a plurality of individual tasks associated with an expandable task row. The expandable task row may include an expand/collapse element, and the second user request may be associated with the expand/collapse element.

In the illustrative method 1100 shown in FIG. 11, at step 1110, a computing device (e.g., the computing device 100 shown in FIG. 1) presents a dynamic progress view for at least a portion of an interactive chart (e.g., a task row associated with one or more tasks). At step 1120, the computing device receives user input associated with the dynamic progress view. At step 1130, the computing device automatically performs one or more of the following steps responsive to the received user input: (a) presenting additional information about a task or project associated with the interactive chart; (b) generating a notification associated with the interactive chart; (c) updating resource allocation for a task associated with the interactive chart; or (d) adjusting a projected completion time for a task associated with the interactive chart. For example, steps (b) and (d) may be performed, and the notification of step (b) may include information relating to the adjusted projected completion time of step (d). As another example, steps (b) and (c) may be performed, and the notification of step (b) may include information relating to the updated resource allocation of step (c).

In the above described methods or other techniques described herein, the computing device may be in communication with a remote computer system (e.g., one or more server computers), and the dynamic progress view may include project information (e.g., project schedule information, resource allocation information, etc.) received from the remote computer system. The dynamic progress view also may include project information received from a local project cache on the computing device. Changes to the project information (e.g., changes made by a user interacting with the computing device) may be synchronized back to the remote computer system.

### Illustrative User Interface Features, Operations, and Elements

In described embodiments, user interface operations (e.g., scrolling operations, zoom operations, panning operations, activation of user interface elements such as buttons or menu options, etc.) can be initiated and/or controlled in response to user input events (e.g., a touch of a button, a gesture or tap on a touchscreen, or the like). User interface operations permit user interaction with charts and views. The available user interface operations, as well as the particular input that is used to initiate or control the available user interface options, can vary depending on factors such as the capabilities of the device (e.g., whether the device has a touchscreen), the underlying operating system, user interface design, user preferences, or other factors.

Scrolling operations (e.g., horizontal scrolling or vertical scrolling) can be initiated and/or controlled by user input such as a button press or touch, a gesture on a touchscreen (e.g., a horizontal flick gesture), or the like. Zoom operations (e.g., zoom-in operations, zoom-out operations) can be initiated and/or controlled by user input such as a button press or touch, a gesture on a touchscreen (e.g., a tap or pinch gesture), or the like. Zoom operations can be useful for viewing or interacting with a chart at different levels of detail. The effect of a zoom operation may vary depending on the current zoom level, the direction and/or magnitude of the zoom, the nature of the user input, or other factors. Zoom operations can be initiated and/or controlled by gestures in a touch-enabled interface. For example, a zoom-in operation can be initiated by a pinch gesture, in which two points of contact (e.g., by a user's fingers) are brought closer together during the gesture, and a zoom-out operation can be initiated by an “un-pinch” gesture, in which two points of contact are moved further apart during the gesture. The effect of a zoom operation can depend on the magnitude of the gesture (e.g., the change in distance between the contact points), the direction of the gesture (e.g., whether the gesture is a pinch or un-pinch gesture), the angle of the gesture (e.g., the angle relative to a horizontal or vertical axis), the current zoom level, and/or other factors. A single gesture can lead to any of several possible zoom effects depending on the characteristics of the gesture, as described in further detail below.

In addition to scrolling operations and zoom operations, other user interface operations can permit other types of user interaction with charts and views. For example, a user can interact with user interface elements by performing a tap gesture or a press-and-hold gesture on a designated hit area in a row, if the hit area is within the display area. A tap or press-and-hold gesture can be recognized if the gesture occurs in a designated area of the display corresponding to a portion of the user interface. Such a designated area is referred to herein as a “hit area.”

In at least one embodiment, the following user interface operations can be initiated by a tap gesture on a designated hit area in a row, if the hit area is within the display area.

Tap expand/collapse element: If an expand/collapse element (e.g., a box) is present (e.g., if a row has children) tapping in an area on or near the element (e.g., a row-height square area) can toggle the expanded/collapsed state. In at least one embodiment, the hit or tap area extends beyond the visible element and potentially even covers a small part of other content outside the expand/collapse element (e.g., text to its right) to ensure that the hit area is big enough for easy interaction.

Tap bar/marker to open a row view: Tapping on the bar or marker (e.g., a task bar, a group bar, a milestone marker, etc.) in a row can open a row view. In at least one embodiment, the row to be viewed is opened in a “view row” form, and the user can move to the next or previous row or invoke an editing operation from that view. If the row is edited, the view can be refreshed to show any corresponding changes.

The above effects may be presented temporally, for a period of time after invocation by the user, or for so long as the user holds a given button or item on the page, for a “show me” effect on the data element selected. In this way, a temporary view of the information may be viewed by the user, without changing the view permanently.

### Illustrative Devices and Operating Environments

Unless otherwise specified in the context of specific examples, described techniques and tools may be implemented by any suitable computing devices, including, but not limited to, laptop computers, desktop computers, smart phones, tablet computers, and/or the like.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location.

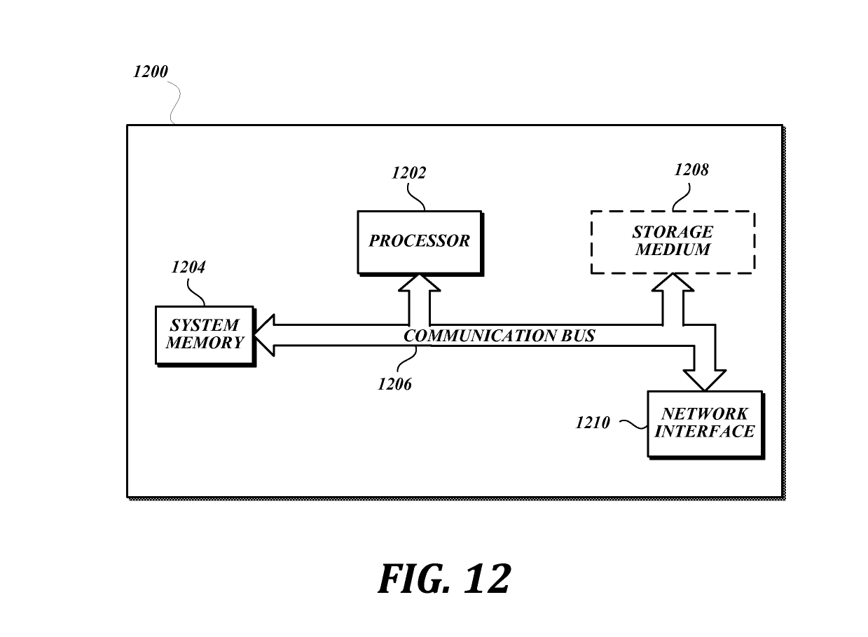

FIG. 12 is a block diagram that illustrates aspects of an illustrative computing device 1200 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 1200 includes at least one processor 1202 and a system memory 1204 connected by a communication bus 1206. Depending on the exact configuration and type of device, the system memory 1204 may be volatile or nonvolatile memory, such as read only memory (“ROM”), random access memory (“RAM”), EEPROM, flash memory, or other memory technology. Those of ordinary skill in the art and others will recognize that system memory 1204 typically stores data and/or program modules that are immediately accessible to and/or currently being operated on by the processor 1202. In this regard, the processor 1202 may serve as a computational center of the computing device 1200 by supporting the execution of instructions.

As further illustrated in FIG. 12, the computing device 1200 may include a network interface 1210 comprising one or more components for communicating with other devices over a network. Embodiments of the present disclosure may access basic services that utilize the network interface 1210 to perform communications using common network protocols. The network interface 1210 may be used to access services such as a distributed file system, a search service, a database service (e.g., a SQL database service), or other services. The network interface 1210 may also include a wireless network interface configured to communicate via one or more wireless communication protocols, such as WiFi, 2G, 3G, 4G, LTE, WiMAX, Bluetooth, and/or the like, with locally networked or remotely networked systems and devices.

In the illustrative embodiment depicted in FIG. 12, the computing device 1200 also includes a storage medium 1208. However, services may be accessed using a computing device that does not include means for persisting data to a local storage medium. Therefore, the storage medium 1208 depicted in FIG. 12 is optional. In any event, the storage medium 1208 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and non-removable media implemented in any method or technology capable of storing information, such as computer-readable instructions, data structures, program modules, in-memory databases, or other data. In this regard, the system memory 1204 and storage medium 1208 depicted in FIG. 12 are examples of computer-readable media.

For ease of illustration and because it is not important for an understanding of the claimed subject matter, FIG. 12 does not show some of the typical components of many computing devices. In this regard, the computing device 1200 may include input devices, such as a keyboard, keypad, mouse, trackball, microphone, video camera, touchpad, touchscreen, electronic pen, stylus, and/or the like. Such input devices may be coupled to the computing device 1200 by wired or wireless connections including RF, infrared, serial, parallel, Bluetooth, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 1200 (e.g., a client device), or can be integral components of the computing device 1200. In some embodiments, multiple input devices may be combined into a single, multifunction input device (e.g., a video camera with an integrated microphone). Any suitable input device either currently known or developed in the future may be used with systems described herein.

The computing device 1200 may also include output devices such as a display, speakers, printer, etc. The output devices may include video output devices such as a display or touchscreen. The output devices also may include audio output devices such as external speakers or earphones. The output devices can be separate from and communicatively coupled to the computing device 1200, or can be integral components of the computing device 1200. In some embodiments, multiple output devices may be combined into a single device (e.g., a display with built-in speakers). Further, some devices (e.g., touchscreens) may include both input and output functionality integrated into the same input/output device. Any suitable output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### Extensions and Alternatives

Although some embodiments that may be used for project scheduling and collaboration are described herein with reference to Gantt charts, it should be understood that such embodiments may also be applied to other types of project scheduling charts, or other charts that are not specifically limited to project scheduling, but have features in which an interactive chart of the progress of related tasks or other scheduled items can be presented to a user.

Although some embodiments are described herein with reference to burn-down graphs that track work remaining, similar principles could be used to track work completed (e.g., in a burn-up graph, a task list, a calendar view, an activity graph, etc.). Although some examples are described herein with regard to illustrative touch-enabled mobile computing devices and a corresponding application that can be executed on the illustrative devices, the principles described herein also can be applied to other computing devices, whether such computing devices employ touchscreen input or other input modes.

For touch-enabled devices, many different types of touch input can be used, and touch input can be interpreted in different ways. Inertia effects, friction effects, and the like can be used to provide a more realistic feel for touch input. For example, in a touch-enabled interface, a flick gesture can be used to initiate a scrolling motion at an initial velocity that gradually decreases (e.g., based on a friction coefficient) before coming to rest.

Visual display areas may represent defined data sets and metadata, and such information may be displayed, reports may be generated, and/or actions may be taken responsive to such information through any number of user interface devices (e.g., mouse, keyboard, keypad, touchpad, touch-enabled display, etc.) Multiple display devices may be used with the system.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The elements shown in the user interfaces can be modified, supplemented, or replaced with other elements in various possible implementations.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the invention in which an exclusive property or privilege is claimed are defined as follows:

1. A computer-implemented method comprising:
by a computing device, displaying at least a portion of an interactive chart in a first view;
by the computing device, receiving a first user request for a change in the view; and
by the computing device, updating the view responsive to the first user request, wherein the updated view comprises a dynamic progress view.

2. The computer-implemented method of claim 1 further comprising:
by the computing device, receiving a second user request for a change in the view; and
by the computing device, further updating the view responsive to the second user request, wherein the further updated view comprises representations of a plurality of individual tasks associated with an expandable task row.

3. The computer-implemented method of claim 2, wherein the expandable task row comprises an expand/collapse element, and wherein the second user request is associated with the expand/collapse element.

4. The computer-implemented method of claim 1, wherein the dynamic progress view comprises a burn-down graph.

5. The computer-implemented method of claim 1, wherein the computing device is in communication with a remote computer system, and wherein the dynamic progress view comprises project information received from the remote computer system.

6. The computer-implemented method of claim 5, wherein the information received from the remote computer system comprises project schedule information

7. The computer-implemented method of claim 1, wherein the dynamic progress view comprises project information received from a local project cache on the computing device.

8. The computer-implemented method of claim 7, wherein the computing device is in communication with a remote computer system, and wherein one or more changes to the project information are synchronized back to the remote computer system.

9. The computer-implemented method of claim 1, wherein a task row in the interactive chart is height-adjusted to accommodate the dynamic progress view.

10. The computer-implemented method of claim 1, wherein the computing device comprises a touchscreen, and wherein the first user request is received via input to the touchscreen.

11. A computer-implemented method comprising:
by a computing device, presenting a dynamic progress view for at least a portion of an interactive chart;
by the computing device, receiving user input associated with the dynamic progress view of the interactive chart; and
responsive to the received user input, automatically performing one or more of the following:
(a) presenting additional information about a task or project associated with the interactive chart;
(b) generating a notification associated with the interactive chart;
(c) updating resource allocation for a task associated with the interactive chart;
(d) adjusting a projected completion time for a task associated with the interactive chart.

12. The computer-implemented method of claim 11, wherein the dynamic progress view comprises a burn-down graph.

13. The computer-implemented method of claim 11, wherein the computing device is in communication with a remote computer system, and wherein the interactive chart comprises information received from the remote computer system.

14. The computer-implemented method of claim 13, wherein the information received from the remote computer system comprises project information.

15. The computer-implemented method of claim 11, wherein the computing device is in communication with a remote computer system, and wherein one or more changes responsive to the received user input are synchronized back to the remote computer system.

16. The computer-implemented method of claim 11, wherein the computing device comprises a touchscreen, and wherein the user input comprises touch or gesture input.

17. The computer-implemented method of claim 11, wherein at least steps (b) and (d) are performed, and wherein the notification comprises information relating to the adjusted projected completion time.

18. The computer-implemented method of claim 11, wherein at least steps (b) and (c) are performed, and wherein the notification comprises information relating to the updated resource allocation.

19. A non-transitory computer-readable medium having instructions stored thereon that, when executed, cause a computing device to:
display at least a portion of an interactive chart in a first view;
receive a first user request for a change in the view; and
update the view responsive to the first user request, wherein the updated view comprises a dynamic progress view.

20. A non-transitory computer-readable medium having instructions stored thereon that, when executed, cause a computing device to:
presenting a dynamic progress view for at least a portion of an interactive chart;
receiving user input associated with the interactive chart; and
responsive to the received user input, automatically performing one or more of the following:
(a) present additional information about a task or project associated with the interactive chart;
(b) generate a notification associated with the interactive chart;
(c) update resource allocation for a task associated with the interactive chart;
(d) adjust a projected completion time for a task associated with the interactive chart.
